(19) United States
(12) Patent Application Publication
(10) Pub. No.: US 2022/0309452 A1
(43) Pub. Date: Sep. 29, 2022

(54) TRACKING CONSOLIDATED SHIPMENT ORDERS

(71) Applicant: International Business Machines Corporation, Armonk, NY (US)

(72) Inventors: Ikenna Precious Chima, New York, NY (US); Zachary A. Silverstein, Austin, TX (US); Matthew Huntebrinker, O' Fallon, MO (US); KYLE HOLMES, Wappingers Falls, NY (US); Emilio Fiallos, Belleville, NJ (US)

(21) Appl. No.: 17/209,397

(22) Filed: Mar. 23, 2021

(51) Int. Cl. G06Q 10/08; G06Q 30/06; G06Q 20/20; G06F 40/295

(52) U.S. Cl. CPC G06Q 10/0833; G06Q 30/0637; G06Q 20/209; G06F 40/295

(57) ABSTRACT

Embodiments herein disclose computer-implemented methods, computer program products and computer systems for tracking consolidated shipment orders. The computer-implemented method may include one or more processors configured for detecting a point-of-sale (POS) webpage displayed on a user interface of a computing device; determining user authorization exists to automatically track and consolidate shipment orders detected on the POS webpage; scraping product purchase data from the POS webpage, the product purchase data corresponding to a product and a shipping service; accessing a user email account to retrieve product purchase confirmation data corresponding to the product purchase data; comparing the product purchase data and the product purchase confirmation data to generate an overlap score; and validating the product purchase data and the product purchase confirmation data if the overlap score satisfies a predetermined threshold.

### BACKGROUND

The present invention relates generally to the field of tracking packages, and more particularly to tracking consolidated shipment of e-commerce orders.

Electronic commerce (e-commerce) is defined as the activity of electronically buying and/or selling of products and services online or over the internet. E-commerce is based on technologies such as electronic funds transfer, mobile commerce, supply chain management, internet marketing, online transaction processing, electronic data interchange (EDI), inventory management systems, and automated data collection systems. E-commerce is driven by the technological advances of the semiconductor industry, including home computer and handheld mobile devices, and to date, is a large sector of the current electronics industry. Modern e-commerce typically uses the world wide web for at least one part of the transaction life cycle, although it may also use other technologies such as e-mail.

E-commerce is emerging as an essential sales channel for companies and, by some estimates, will become the primary sales channel in the future. The COVID-19 pandemic has accelerated E-commerce adoption and companies that cater to work from home lifestyles have seen dramatic surges in new members and repeat purchases. Tracking packages usually involves a user login into the purchase site, clicking a tracking link contained in an email, or entering the tracking number in the carrier's website. Although this process requires minimal effort for a single item, it can become onerous with increases in sites and orders. The risk of missed or mismanaged packages also increases. Online holiday shopping is a prime example of this effect.

### SUMMARY

The present invention is described in various embodiments disclosing methods, computer program products, and computer systems for authenticating a user. One embodiment of the present disclosure is a computer-implemented method for tracking consolidated shipment orders, the computer-implemented method may include one or more processors configured for detecting a point-of-sale (POS) webpage displayed on a user interface of a computing device; determining user authorization exists to automatically track and consolidate shipment orders detected on a POS webpage; scraping product purchase data from the POS webpage, the product purchase data corresponding to a product and a shipping service; accessing a user email account to retrieve product purchase confirmation data corresponding to the product purchase data; comparing the product purchase data and the product purchase confirmation data to generate an overlap score; and validating the product purchase data and the product purchase confirmation data if the overlap score satisfies a predetermined threshold.

In an embodiment, the POS webpage is detected by identifying one or more trigger phrases comprising confirm purchase, shipping address, and shipping method.

In an embodiment, the computer-implemented method may further include one or more processors configured for, responsive to detecting the POS webpage, generating a track shipment request notification via the user interface of the computing device; and presenting a user selectable icon on the user interface of the computing device configured to receive user input to either track or not track the product using the shipping service. In an embodiment, the computer-implemented method may further include one or more processors configured for receiving the user input to track the product using the shipping service.

In an embodiment, the computer-implemented method may further include one or more processors configured for processing, using a Natural Language Processor (NLP) engine, the product purchase data to identify the user email account and shipping service data comprising one or more of an order number, tracking number, order date, expected delivery date, and carrier.

In an embodiment, the computer-implemented method may further include one or more processors configured for receiving user authorization to access the user email account associated with the product purchase data.

In an embodiment, the computer-implemented method may further include one or more processors configured for presenting an error message via the user interface if the overlap score does not satisfy the predetermined threshold, the error message indicating one or more discrepancies between the product purchase data and the product purchase confirmation data.

### BRIEF DESCRIPTION OF THE DRAWINGS

FIG. 1 depicts a block diagram of a distributed network environment for tracking consolidated shipment orders, in accordance with an embodiment of the present invention;

FIG. 2 depicts a flow chart of a system for tracking consolidated shipment orders, in accordance with an embodiment of the present invention;

FIG. 3 depicts a flow chart of a computer-implemented method for tracking consolidated shipment orders, in accordance with an embodiment of the present invention; and

FIG. 4 depicts a block diagram of a computing device of distributed network environment, in accordance with an embodiment of the present invention.

### DETAILED DESCRIPTION

Package delivery tracking becomes an error prone and onerous process for an individual when multiple orders are made from multiple sites. Traditional tracking methods such as sales site logins or searching through email to find a tracking link are inefficient and time consuming.

The present invention addresses the efficiency issues inherent to tracking multiple items being shipped from different source locations and vendors. Embodiments of the present invention provide a computer-implemented method for consolidating shipment details and monitoring orders after an e-commerce purchase. Embodiments of the present invention detect a point-of-sale (POS) page is generated on a user interface of a computing device, wherein the user may have provided authorization to gather data from the POS page to perform consolidating and tracking of a shipment order. If no authorization was previously provided, a user prompt may be generated to receive user authorization once the POS page is detected. Further, embodiments of the present invention may scrape the POS page and purchase confirmation emails and query shipment carrier websites to keep shipment tracking information up to date.

Further, embodiments of present invention may, at a first time, begin to track a first shipment order, and at a second time, begin to track a second or later shipment orders all in one consolidated platform to allow the user to track the first, second and later shipment orders all in one place. The same processes used to track the first shipment order may be used to track later shipment orders while each of the orders are still on its way to the user shipping address. Thus, the user would not be burdened with navigating to multiple different carrier websites in order to track the status of each shipment order.

Scraping can be performed by a web scraper as a computer program executed by one or more processors. The scraping can be data scraping, which can include one or more of a combination of user interface scraping, web scraping, report mining, etc. Web scraping can be performed to extract information from webpages. This extracting can be performed by scrapers that simulate manual exploration of web. The simulation can be performed by implementing either hypertext transfer protocol (HTTP) or by embedding webpage browsers. While web indexing can index web content using a bot, web scraping can be directed to perform transformation of unstructured web content, typically in HTML format, into structured data that can be stored and analyzed in a central local database. This transformation can be based on content of an XML file associated with the scraper, wherein the content can include one or more or attributes, regular expressions, and rules.

In an embodiment, a computer-implemented method may be executed by one or more processors in a system configured to leverage a user's POS data and product purchase confirmation data (e.g., email confirmation) to query, monitor, and update shipment statuses of all in-transit orders. Further, the one or more processors may be configured to trigger an alert to scrape sale data when a user is viewing or navigating a POS webpage. POS information may be scraped upon user authorization and consent to allow the purchase confirmation information in the user's email account to be accessed and collected.

In an embodiment, the one or more processors may be configured to, responsive to determining that a user is viewing a POS page, generate and present a prompt to a user via a user interface of a computing device. For example, the prompt may include the phrase, “Would you like to have this shipment tracked?” and appearing in response to detecting the user is viewing or navigating the order confirmation page of an online website. Further, the one or more processors may be configured to receive user consent to track the shipment, wherein key fields such as order number, time of sale, email address, estimated delivery date, carrier, and shipment information are collected from the POS page.

In an embodiment, the one or more processors may be configured to determine that user authorization already exists to automatically track and consolidate shipment orders detected on a POS webpage. For example, at a first time, a first POS webpage may be detected corresponding to a first shipment order from a first carrier, wherein user authorization was received to consolidate and track the first shipment order. At a second time that is after the first time, a second POS webpage may be detected corresponding to a second shipment order from a second carrier that is different from the first carrier, wherein user authorization was received to consolidate and track the second shipment order. In this embodiment, the first shipment order and the second shipment order may be consolidated and tracked simultaneously, providing shipment updates to the user based on the first POS page, the second POS page, and corresponding confirmation emails for each shipment order. Therefore, any changes or updates to the shipment order statuses will be provided to the user in a central platform presenting information in the user interface of the computing device associated with the user.

In an embodiment, information displayed on the confirmation email may be scraped and used to enhance and validate POS data. For example, the order confirmation email having matching order information (e.g., order number, delivery date, etc.) from the online website may be retrieved from an email account associated with the user and represented in the POS data.

In an embodiment, the POS data and email confirmation data may be cross validated or compared to determine if the two data sources match beyond a predetermined threshold, wherein the predetermined threshold may be sufficient to prevent any possible errors. For example, if there are any discrepancies between the POS data and the email confirmation data, then the one or more processors may be configured to generate a notification to the user.

In an embodiment, the one or more processors may be configured to store the POS data and the purchase confirmation data in the email account in a database to begin tracking the shipment. The stored data can also be stored long term with user consent to generate personalized insights on purchase history. Over time, the one or more processors may be configured to organize a rich history of user purchase history and behavior, which can be further used to help budget and strategize future purchases.

In an embodiment, the one or more processors may be configured to update shipping information recurrently by communicating with the carrier application programming interface (API) using the respective tracking number. Further, the one or more processors may be configured to query the updated shipment information from the respective shipment carrier.

In yet another embodiment, a system for tracking consolidated shipment orders may include one or more processors configured for triggering an alert to be presented to a user when the user is detected to be navigating an e-commerce POS webpage. For example, the trigger can be set to alert the user when certain keywords or phrases (e.g., confirm purchase, enter shipping address, select shipping method) are detected on the POS page.

In yet another embodiment, the system for tracking consolidated shipment orders may include one or more processors configured for immediately prompting the user with a request to “Track Shipment”, wherein the user may be presented with a user-selectable element to either track the shipment or not. If the user elects to not track the shipment, the one or more processors may be configured to not take any further action. If the user elects to track the shipment, then the one or more processors may be configured to use a Natural Language Processing (NLP) engine to begin gathering key shipment related metadata (e.g., order number, time of sale, email, estimated delivery, carrier, items purchased).

In an embodiment, the system for tracking consolidated shipment orders may include one or more processors configured for scraping email messages in a user email account containing purchase confirmation information corresponding to the shipment metadata. The correct email message in the user email account may be identified by identifying purchase order fields (e.g., vendor, order number, time of sale) in the email account. In an embodiment, if a user restricts or fails to authorize email access, then the one or more processors may be configured to only use the POS data to track the shipment.

In an embodiment, the system for tracking consolidated shipment orders may include one or more processors configured for cross validating email confirmation metadata with the POS data, wherein any identified discrepancies may be communicated to the user via the user interface of the computing device. Further, the one or more processors may be configured to monitor the user email account for any updates or changes in the shipment information.

In an embodiment, the system for tracking consolidated shipment orders may include one or more processors configured for storing the POS data and the email confirmation data in a database, wherein the stored data may be used for the duration that the purchased items are in transit and even afterwards to create personalized and informative purchase trends.

In an embodiment, the system for tracking consolidated shipment orders may include one or more processors configured for iteratively querying the carrier and/or vendor website to retrieve shipment status updates, wherein updates may be transmitted to the database for processing to present to the user in other forms. For example, shipment details and information from the database may be used to present information corresponding to the order tracking in a variety of formats (e.g., dashboard, report, notification, etc.).

The present invention will now be described in detail with reference to the Figures.

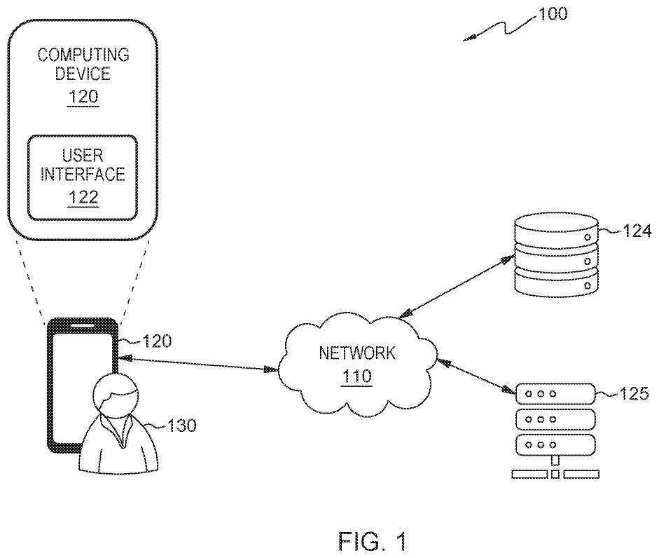

FIG. 1 depicts a block diagram of a distributed network environment 100 for tracking consolidated shipment orders, in accordance with an embodiment of the present invention. FIG. 1 provides only an illustration of one embodiment of the present invention and does not imply any limitations with regard to the environments in which different embodiments may be implemented. Distributed network environment 100 represents a system executing a computer program for tracking consolidated shipment orders from creation of the order through the delivery of the order. In the depicted embodiment, the distributed network environment 100 includes computing device 120 in communication with network 110. Computing device 120 may be associated with user 130. Distributed network environment 100 may include database(s) 124 and server(s) 125 in communication with network 110. Distributed network environment 100 may also include additional servers, computers, sensors, or other devices not shown.

Network 110 operates as a computing network that can be, for example, a local area network (LAN), a wide area network (WAN), or a combination of the two, and can include wired, wireless, or fiber optic connections. In general, network 110 can be any combination of connections and protocols that will support communications between computing device 120 and database 124 and/or server 125. It is further understood that in some embodiments network 110 is optional and distributed network environment 100 can operate as a stand-alone system, where in other embodiments, network 110 may be configured to enable more than one computing device to share a joint database using network 110.

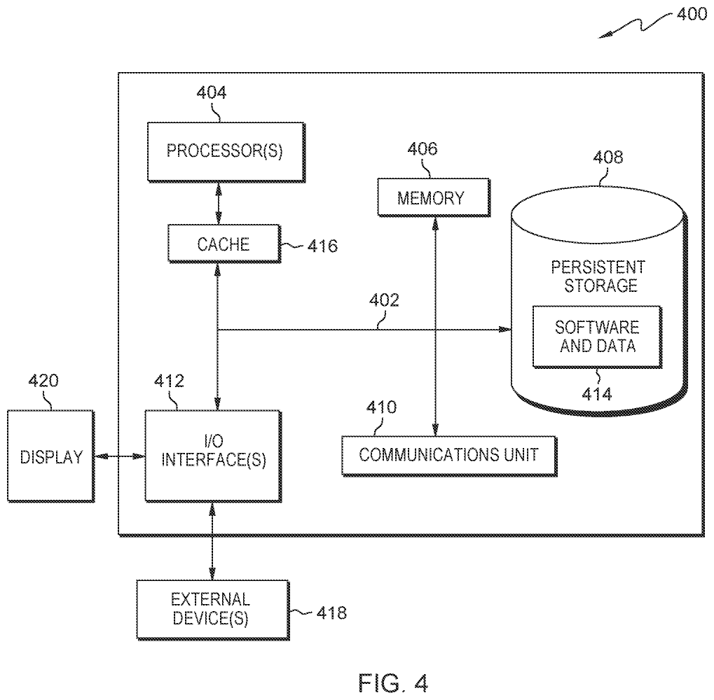

Computing device 120 includes user interface 122 and operates to execute at least a part of the computer program for tracking consolidated shipment orders. Computing device 120 be configured to send and/or receive data from network 110. In some embodiments, computing device 120 may be a management server, a web server, or any other electronic device or computing system capable of receiving and sending data. In some embodiments, computing device 120 may be a laptop computer, tablet computer, netbook computer, personal computer (PC), a desktop computer, a smart phone, or any programmable electronic device capable of communicating with database(s) 124, server(s) 125 via network 110. Computing device 120 may include components as described in further detail in FIG. 4.

Database 124 operates as a repository for data flowing through network 110. Examples of data include user data, device data, network data, product purchase data, product purchase confirmation data and data corresponding to tracking consolidated shipment orders. A database is an organized collection of data. Database 124 can be implemented with any type of storage device capable of storing data and configuration files that can be accessed and utilized by computing device 120, such as a database server, a hard disk drive, or a flash memory. In an embodiment, database 124 is accessed by computing device 120 to store data corresponding to tracking order shipments. In another embodiment, database 124 is accessed by computing device 120 to access user data, device data, network data, product purchase data, product purchase confirmation data and data corresponding to tracking order shipments. In another embodiment, database 124 may reside elsewhere within distributed network environment 100 provided database 124 has access to network 110.

Server 125 can be a standalone computing device, a management server, a web server, or any other electronic device or computing system capable of receiving, sending, and processing data and capable of communicating with computing device 120 and/or database 124 via network 110. In other embodiments, server 125 represents a server computing system utilizing multiple computers as a server system, such as a cloud computing environment. In yet other embodiments, server 125 represents a computing system utilizing clustered computers and components (e.g., database server computers, application server computers, etc.) that act as a single pool of seamless resources when accessed within distributed data processing environment 100. Server 125 may include components as described in further detail in FIG. 4.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. The system executing the computer program from tracking consolidated shipment orders enables the authorized and secure processing of personal data.

The system executing the computer program from tracking consolidated shipment orders provides informed consent, with notice of the collection of personal and/or confidential company data, allowing the user to opt in or opt out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. The system executing the computer program from tracking consolidated shipment orders provides information regarding personal and/or confidential company data and the nature (e.g., type, scope, purpose, duration, etc.) of the processing. The system executing the computer program from tracking consolidated shipment orders provides the user with copies of stored personal and/or confidential company data. The system executing the computer program from tracking consolidated shipment orders allows the correction or completion of incorrect or incomplete personal and/or confidential company data. The system executing the computer program from tracking consolidated shipment orders allows for the immediate deletion of personal and/or confidential company data.

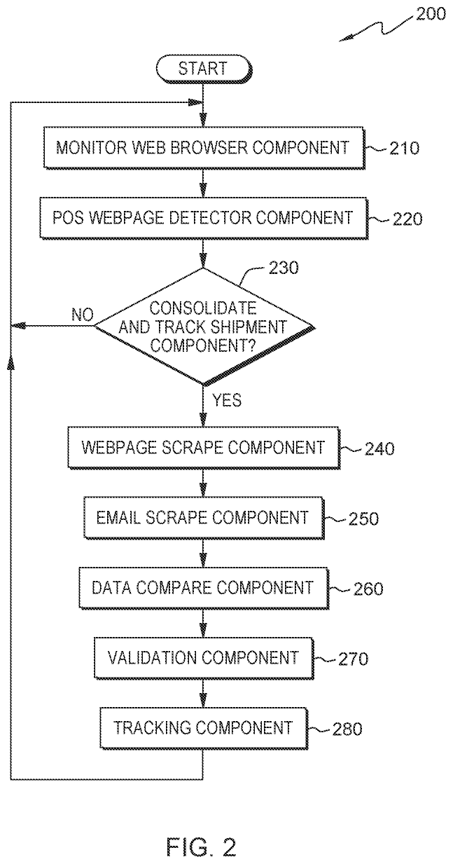

FIG. 2 depicts a flow chart of a system 200 for tracking consolidated shipment orders, in accordance with an embodiment of the present invention.

In an embodiment, system 200 for tracking consolidated shipment orders may include one or more processors configured for monitoring a web browser for user activity. For example, system 200 may facilitate a user to subscribe to a service to provide consolidated shipment tracking information, wherein the service continuously monitors a web browser of a computing device user interface. Further, system 200 may include a monitor web browser component 210 configured to monitor the web browser for specific types of activity relevant to tracking shipment orders.

In an embodiment, system 200 for tracking consolidated shipment orders may include a POS webpage detector component 220 configured to detect when a web browser has generated a POS web page. For example, the one or more processors may be configured for detecting a POS webpage displayed on a user interface of a computing device. The POS webpage may be detected by identifying one or more trigger phrases chosen from one or more of confirm purchase, shipping address, and shipping method. Other trigger phrases related to shipping orders may be used to detect the POS webpage.

In an embodiment, system 200 for tracking consolidated shipment orders may include one or more processors configured for, responsive to detecting the POS webpage, generating a track shipment request notification via the user interface of the computing device; and presenting a user selectable icon on the user interface of the computing device configured to receive user input to either track or not track the product using the shipping service. For example, system 200 may include a consolidate and track shipment 230 component configured to generate a notification to request whether or not the user would like to consolidate and track the shipment order appearing on the POS webpage. For example, the one or more processors may be configured to generate a notification to solicit input from the user for the user to choose to consolidate and track the shipment order or choose to not consolidate and track the shipment order placed by the user. If the user chooses to consolidate and track the shipment order, then the one or more processors may be configured to scrape the POS webpage using the webpage scrape component 240 to gather details about the shipment order. If the user chooses to not consolidate and track the shipment order, then the one or more processors may be configured to continue to monitor the webpage browser using the monitor web browser component 210.

In an embodiment, system 200 for tracking consolidated shipment orders may include one or more processors configured for receiving the user input to track the product using the shipping service.

In an embodiment, system 200 for tracking consolidated shipment orders may include a webpage scrape component 240 configured for scraping product purchase data from the POS webpage, wherein the product purchase data may correspond to a product and a shipping service. For example, a product may include one or more physical items that require a shipping services to be engaged to deliver the physical items from their current location to the user-specified location. The shipping service may include data corresponding to a carrier, a shipping type, a shipping time, or other shipping details that may be relevant to shipping a package from one location to another.

In an embodiment, system 200 for tracking consolidated shipment orders may include one or more processors configured for processing, using a Natural Language Processor (NLP) engine, the product purchase data to identify the user email account and shipping service data comprising one or more of an order number, tracking number, order date, expected delivery date, and carrier. In an embodiment, NLP engine may be configured for extracting named entities, keywords and phrases, purchase receipts, and purchase history to locate and identify unshipped items, tracking numbers and other metadata associated with the purchase.

In an embodiment, system 200 for tracking consolidated shipment orders may include email scrape component 250 configured for accessing a user email account to retrieve product purchase confirmation data corresponding to the product purchase data. In an embodiment, the one or more processors may be configured for, prior to accessing the user email account, receiving user authorization to access the user email account associated with the product purchase data.

In an embodiment, system 200 for tracking consolidated shipment orders may include data compare component 260 configured for comparing the product purchase data and the product purchase confirmation data to generate an overlap score. The one or more processors may also be configured for presenting an error message via the user interface if the overlap score does not satisfy the predetermined threshold, wherein the error message may indicate one or more discrepancies between the product purchase data and the product purchase confirmation data.

In an embodiment, system 200 for tracking consolidated shipment orders may include validation component 270 configured for validating the product purchase data and the product purchase confirmation data if the overlap score satisfies a predetermined threshold. For example, both the product purchase data and the product purchase confirmation data may include an order number field, wherein if the order numbers are inconsistent by one digit, then the predetermined threshold will not be satisfied. Further, the one or more processors may be configured to notify the user of the inconsistent order numbers via a prompt. Further, both the product purchase data and the product purchase confirmation data may include an address field, wherein if the zip codes in address fields are inconsistent by one digit, then the predetermined threshold will not be satisfied. In another example, both the product purchase data and the product purchase confirmation data may include a name field, wherein if one letter in the first name or last name is inconsistent, then the predetermined threshold will be satisfied because inconsistent letters in names may not be sufficient to result in a shipping error, as opposed to inconsistent numbers in address and order numbers.

In an embodiment, system 200 for tracking consolidated shipment orders may include tracking component 280 configured for storing the POS data and the email confirmation data in a database, wherein the stored data may be used for the duration that the purchased items are in transit and even afterwards, depending on user approval/authorization, to create personalized and informative purchase trends. Tracking component 280 may also be configured for iteratively querying the carrier and/or vendor website to retrieve shipment status updates, wherein updates may be transmitted to the database for processing to present to the user in other forms. For example, shipment details and information from the database may be used to present information corresponding to the order tracking in a variety of formats (e.g., dashboard, report, notification, etc.).

In an embodiment, tracking component 280 may also be configured for monitoring the user email account for any updates or changes in the shipment information. For example, incoming emails from carriers and e-commerce websites may be monitored for shipping information and updates to shipping information. The one or more processors may be configured for extracting the relevant shipping information and updates to the shipping information to cross validate the extracted information with the POS data.

In an embodiment, tracking component 280 may also be configured for storing shipping information in a database and generating project tracking statistics to be presented in the user interface of the computing device associated with the user. Further, tracking component 280 may be configured to query known tracking information stored in the database on time desired time-frequency (e.g., hourly) and update the database and the user interface accordingly.

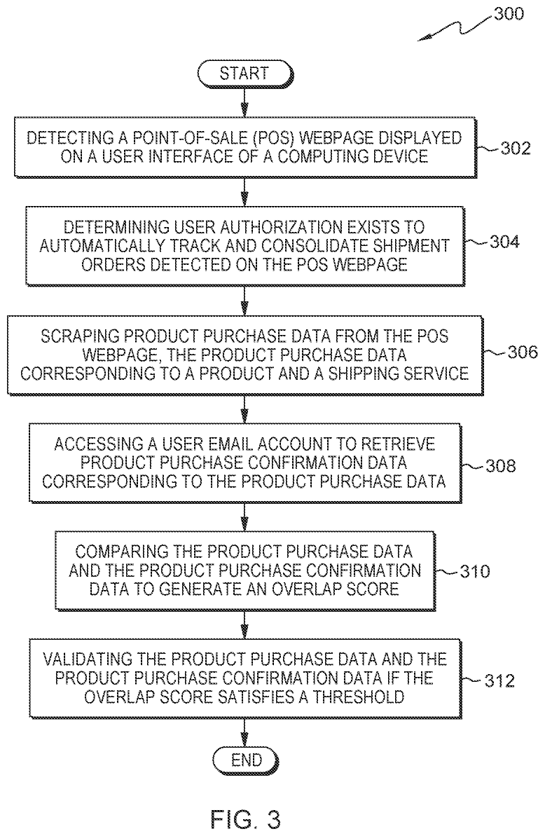

FIG. 3 depicts a flow chart of a computer-implemented method 300 for tracking consolidated shipment orders, in accordance with an embodiment of the present invention.

In an embodiment, computer-implemented method 300 may include one or more processors configured for detecting 302 a POS webpage displayed on a user interface of a computing device. In an embodiment, the POS webpage is detected by identifying, by the one or more processors, one or more trigger phrases comprising confirm purchase, shipping address, and shipping method.

In an embodiment, computer-implemented method 300 may include one or more processors configured for determining 304 user authorization exists to automatically track and consolidate shipment orders detected on the POS webpage.

In an embodiment, computer-implemented method 300, responsive to detecting 302 the POS webpage, the one or more processors may be configured for generating a track shipment request notification via the user interface of the computing device and presenting a user selectable icon on the user interface of the computing device configured to receive user input to either track or not track the product using the shipping service. Further, the one or more processors may be configured for receiving the user input to track the product using the shipping service.

In an embodiment, computer-implemented method 300 may include one or more processors configured for scraping 306 product purchase data from the POS webpage, the product purchase data corresponding to a product and a shipping service. Further, the one or more processors may be configured for processing, using an NLP engine, the product purchase data to identify the user email account and shipping service data comprising one or more of an order number, tracking number, order date, expected delivery date, and carrier.

In an embodiment, computer-implemented method 300 may include one or more processors configured for accessing 308 a user email account to retrieve product purchase confirmation data corresponding to the product purchase data. Further, prior to accessing 308 the user email account, the one or more processors may be configured for receiving user authorization to access the user email account associated with the product purchase data.

In an embodiment, computer-implemented method 300 may include one or more processors configured for comparing 310 the product purchase data and the product purchase confirmation data to generate an overlap score. In an embodiment, the one or more processors may be configured for presenting an error message via the user interface if the overlap score does not satisfy the predetermined threshold, the error message indicating one or more discrepancies between the product purchase data and the product purchase confirmation data.

In an embodiment, computer-implemented method 300 may include one or more processors configured for validating 312 the product purchase data and the product purchase confirmation data if the overlap score satisfies a threshold. For example, the order confirmation email having matching order information (e.g., order number, delivery date, etc.) from the online website may be retrieved from an email account associated with the user and represented in the POS data. The POS data and email confirmation data may be cross validated or compared to determine if the two data sources match beyond a predetermined threshold, wherein the predetermined threshold may be sufficient to prevent any possible errors. If there are any discrepancies between the POS data and the email confirmation data, then the one or more processors may be configured to generate a notification to the user.

FIG. 4 depicts a block diagram of a computing device of distributed network environment 100, in accordance with an embodiment of the present invention. FIG. 4 depicts a block diagram of computing device 400 suitable for server(s) 125 and computing device 120, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 400 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Programs may be stored in persistent storage 408 and in memory 406 for execution and/or access by one or more of the respective computer processors 404 via cache 416. In an embodiment, persistent storage 408 includes a magnetic hard disk drive. Alternatively, or in addition to a magnetic hard disk drive, persistent storage 408 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Programs, as described herein, may be downloaded to persistent storage 408 through communications unit 410.

I/O interface(s) 412 allows for input and output of data with other devices that may be connected to computing device 120. For example, I/O interface 412 may provide a connection to external devices 418 such as image sensor, a keyboard, a keypad, a touch screen, and/or some other suitable input device. External devices 418 can also include portable computer readable storage media such as, for example, thumb drives, portable optical or magnetic disks, and memory cards. Software and data 414 used to practice embodiments of the present invention can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The present invention may be a system, a computer-implemented method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for tracking consolidated shipment orders, the computer-implemented method comprising:
detecting, by one or more processors, a point-of-sale (POS) webpage displayed on a user interface of a computing device;
determining, by the one or more processors, user authorization exists to automatically track and consolidate shipment orders detected on the POS webpage;
scraping, by the one or more processors, product purchase data from the POS webpage, the product purchase data corresponding to a product and a shipping service;
accessing, by the one or more processors, a user email account to retrieve product purchase confirmation data corresponding to the product purchase data;
comparing, by the one or more processors, the product purchase data and the product purchase confirmation data to generate an overlap score; and
validating, by the one or more processors, the product purchase data and the product purchase confirmation data if the overlap score satisfies a predetermined threshold.

2. The computer-implemented method of claim 1, wherein the POS webpage is detected by identifying, by the one or more processors, one or more trigger phrases comprising confirm purchase, shipping address, and shipping method.

3. The computer-implemented method of claim 1, further comprising:
responsive to detecting the POS webpage and determining user authorization does not exist, generating, by the one or more processors, a track shipment request notification via the user interface of the computing device; and
presenting, by the one or more processors, a user selectable icon on the user interface of the computing device configured to receive user input to either track or not track the product using the shipping service.

4. The computer-implemented method of claim 3, further comprising:
receiving, by the one or more processors, the user input to track the product using the shipping service.

5. The computer-implemented method of claim 1, further comprising:
processing, using a Natural Language Processor (NLP) engine, the product purchase data to identify the user email account and shipping service data comprising one or more of an order number, tracking number, order date, expected delivery date, and carrier.

6. The computer-implemented method of claim 1, further comprising:
receiving, by the one or more processors, user authorization to access the user email account associated with the product purchase data.

7. The computer-implemented method of claim 1, further comprising:
presenting, by the one or more processors, an error message via the user interface if the overlap score does not satisfy the predetermined threshold, the error message indicating one or more discrepancies between the product purchase data and the product purchase confirmation data.

8. A computer program product for tracking consolidated shipment orders, the computer program product comprising:
one or more computer readable storage media and program instructions collectively stored on the one or more computer readable storage media, the stored program instructions comprising:
program instructions to detect a point-of-sale (POS) webpage displayed on a user interface of a computing device;
program instructions to determine user authorization exists to automatically track and consolidate shipment orders detected on the POS webpage;
program instructions to scrape product purchase data from the POS webpage, the product purchase data corresponding to a product and a shipping service;
program instructions to access a user email account to retrieve product purchase confirmation data corresponding to the product purchase data;
program instructions to compare the product purchase data and the product purchase confirmation data to generate an overlap score; and
program instructions to validate the product purchase data and the product purchase confirmation data if the overlap score satisfies a predetermined threshold.

9. The computer program product of claim 8, wherein the POS webpage is detected by program instructions to identify one or more trigger phrases comprising confirm purchase, shipping address, and shipping method.

10. The computer program product of claim 8, further comprising:
responsive to the program instructions to detect the POS webpage and determine user authorization does not exist, program instructions to generate a track shipment request notification via the user interface of the computing device; and
program instructions to present a user selectable icon on the user interface of the computing device configured to receive user input to either track or not track the product using the shipping service.

11. The computer program product of claim 10, further comprising:
program instructions to receive the user input to track the product using the shipping service.

12. The computer program product of claim 8, further comprising:
program instructions to process, using a Natural Language Processor (NLP) engine, the product purchase data to identify the user email account and shipping service data comprising one or more of an order number, tracking number, order date, expected delivery date, and carrier.

13. The computer program product of claim 8, further comprising:
program instructions to receive user authorization to access the user email account associated with the product purchase data.

14. The computer program product of claim 8, further comprising:
program instructions to present an error message via the user interface if the overlap score does not satisfy the predetermined threshold, the error message indicating one or more discrepancies between the product purchase data and the product purchase confirmation data.

15. A computer system for tracking consolidated shipment orders, the computer system comprising:
one or more computer processors;
one or more computer readable storage media;
program instructions collectively stored on the one or more computer readable storage media for execution by at least one of the one or more computer processors, the stored program instructions comprising:
program instructions to detect a point-of-sale (POS) webpage displayed on a user interface of a computing device;
program instructions to determine user authorization exists to automatically track and consolidate shipment orders detected on the POS webpage;
program instructions to scrape product purchase data from the POS webpage, the product purchase data corresponding to a product and a shipping service;
program instructions to access a user email account to retrieve product purchase confirmation data corresponding to the product purchase data;
program instructions to compare the product purchase data and the product purchase confirmation data to generate an overlap score; and
program instructions to validate the product purchase data and the product purchase confirmation data if the overlap score satisfies a predetermined threshold.

16. The computer system of claim 15, wherein the POS webpage is detected by program instructions to identify one or more trigger phrases comprising confirm purchase, shipping address, and shipping method.

17. The computer system of claim 15, further comprising:
responsive to the program instructions to detect the POS webpage and determine user authorization does not exist, program instructions to generate a track shipment request notification via the user interface of the computing device; and
program instructions to present a user selectable icon on the user interface of the computing device configured to receive user input to either track or not track the product using the shipping service; and
program instructions to receive the user input to track the product using the shipping service.

18. The computer system of claim 15, further comprising:
program instructions to process, using a Natural Language Processor (NLP) engine, the product purchase data to identify the user email account and shipping service data comprising one or more of an order number, tracking number, order date, expected delivery date, and carrier.

19. The computer system of claim 15, further comprising:
program instructions to receive user authorization to access the user email account associated with the product purchase data.

20. The computer system of claim 15, further comprising:
program instructions to present an error message via the user interface if the overlap score does not satisfy the predetermined threshold, the error message indicating one or more discrepancies between the product purchase data and the product purchase confirmation data.
